(19) United States
(12) Patent Application Publication
(10) Pub. No.: US 2012/0284471 A1
(43) Pub. Date: Nov. 8, 2012

(54) VIRTUAL MACHINE DISK MIGRATION

(76) Inventors: Yoon-Bum Hur, Seoul (KR); Dong-Hoon Kim, Gyeonggi-do (KR); Jae-Suk Ahn, Seoul (KR); Ho-Hyun Jeon, Seoul (KR)

(21) Appl. No.: 13/465,283

(22) Filed: May 7, 2012

(30) Foreign Application Priority Data
May 6, 2011 (KR) 10-2011-0043078

(51) Int. Cl. G06F 12/16

(52) U.S. Cl. 711/162; 711/E12.103

(57) ABSTRACT

A method and an apparatus may be provided for migrating a source virtual machine disk of a virtual machine from a first storage device to a second storage device while the virtual machine is running. The method may include creating a target virtual machine disk in the second storage device, replicating the source virtual machine disk of the first storage device to the target virtual machine disk in the second storage device, detecting variation of the source virtual machine disk, reflecting the detected variation on the replication stored in the target virtual machine disk in the second storage device, and assigning the target virtual machine disk of the second storage device as a designated virtual machine disk for the virtual machine.

### CROSS REFERENCE TO PRIOR APPLICATIONS

The present application claims priority under 35 U.S.C. §119 to Korean Patent Application No. 10-2011-0043078 (filed on May 6, 2011), which is hereby incorporated by reference in its entirety.

### FIELD OF THE INVENTION

The present invention relates to a virtual machine and, in particular, to virtual machine disk migration.

### BACKGROUND OF THE INVENTION

A virtual machine is a virtualization of an actual physical computer system. Such a virtual machine may include at least one virtual machine disk, virtualized in a physical storage device. The virtual machine disk may be a file or a set of files on the storage device. From time to time, management and performance of maintenance on the storage device is desirable. In order to manage and maintain virtual machine disks, virtual machine disk migration may be performed. The virtual machine disk migration may be a process of transferring a virtual machine disk from a first physical storage device to a second physical storage device. For convenience and ease of understanding, a storage device may denote a physical storage device, hereinafter.

Such a virtual machine migration may be a simple process when a related virtual machine is not running. When, however, a related virtual machine is running, the virtual machine migration becomes complicated because a virtual machine disk may be frequently updated with data created, modified, or remove by a write process or a read process.

### SUMMARY OF THE INVENTION

This summery is provided to introduce a selection of concepts in a selection of concepts in a simplified from that are further described below in the detailed description with reference to the drawings. This summery is not intended to identify key features or essential features of the claimed subject matter, nor is it intended to limit the scope of the claimed subject matter.

Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present invention, a virtual machine disk may be migrated from a first storage device to a second storage device through taking snapshots of contents of the first storage device and the second storage device.

In accordance with an embodiment of the present invention, a method may be provided for migrating a source virtual machine disk of a virtual machine from a first storage device to a second storage device while the virtual machine is running. The method may include creating a target virtual machine disk in the second storage device, replicating the source virtual machine disk of the first storage device to the target virtual machine disk in the second storage device, detecting variation of the source virtual machine disk, reflecting the detected variation on the replication stored in the target virtual machine disk in the second storage device, and assigning the target virtual machine disk of the second storage device as a designated virtual machine disk for the virtual machine.

The method may further include performing the detecting variation and the reflecting the detected variation regularly at a given interval.

The detecting variation may include comparing the source virtual machine disk with the replication stored in the target virtual machine disk of the second storage device. Or, the detecting variation may include comparing the source virtual machine disk with the target virtual machine disk of the second storage device.

The reflecting the detected variation may include creating a snapshot of the detected variation, and reflecting the snapshot on the replication stored in the virtual machine disk of the second storage device.

The reflecting the snapshot may include updating the replication stored in the virtual machine disk of the second storage device based on the variation included in the snapshot.

After the assigning, the method may include detecting a final variation of the source virtual machine disk, and reflecting the final variation on the replication stored in the target virtual machine disk.

After the assigning, the method may include detecting a final variation of the source virtual machine disk, creating a final snapshot of the final variation, and reflecting the final snapshot on the replication stored in the target virtual machine disk.

In accordance with another embodiment of the present invention, a method may be provided for migrating a source virtual machine disk of a virtual machine from a first storage device to a second storage device while the virtual machine is running. The method may include replicating the source virtual machine disk of the first storage device to the second storage device, detecting variation of the source virtual machine disk, reflecting the detected variation on the replication stored in the second storage device, and assigning the second storage device as a designated storage device for the virtual machine.

The method may include performing the detecting variation and the reflecting the detected variation regularly at a given interval.

The detecting variation may include comparing the source virtual machine disk with the replication stored in the second storage device.

The reflecting the detected variation may include creating a snapshot of the detected variation, and reflecting the snapshot on the replication stored in the second storage device.

The reflecting the snapshot may include updating the replication stored in the second storage device based on the variation included in the snapshot.

The assigning may include creating a target virtual machine disk with the replication stored in the second storage device, and assigning the created target virtual machine disk as a designated virtual machine disk for the virtual machine.

After the assigning, the method may include detecting a final variation of the source virtual machine disk, and reflecting the final variation on the replication stored in the target virtual machine disk.

After the assigning, the method may further include detecting a final variation of the source virtual machine disk, creating a final snapshot of the final variation, and reflecting the final snapshot on the replication stored in the target virtual machine disk of the second storage device.

In accordance with another embodiment of the present invention, a virtual machine may be provided for migrating a virtual machine disk from a first storage device to a second storage device while the virtual machine is running. The virtual machine may include a migration unit, a snapshot controller, and a virtual machine disk controller. The migration unit may be configured to create a target virtual machine disk in the second storage device and to replicate the source virtual machine disk of the first storage device to the target virtual machine disk in the second storage device. The snapshot controller may be configured to detect variation of the source virtual machine disk and to create a snapshot of the detected variation. The virtual machine disk controller may be configured to assign the target virtual machine disk of the second storage device as a designated virtual machine disk for the virtual machine. The migration unit may be configured to reflect the detected variation on the replication stored in the target virtual machine disk in the second storage device based on the snapshot.

The snapshot controller may be configured to compare the source virtual machine disk with the replication stored in the target virtual machine disk of the second storage device and to create the snapshot based on the comparison result.

The snapshot controller may be configured to detect a final variation of the source virtual machine disk and to create a final snapshot of the final variation, after the virtual machine disk controlled assigns the target virtual machine disk as the designated jai machine disk for the virtual machine. The migration unit may be configured to reflect the final variation on replication stored in the target virtual machine disk after the virtual machine disk controlled assigns the target virtual machine disk as the designated virtual machine disk for the virtual machine.

The snapshot controller may be configured to regularly detect and create the variation and the snapshot at a given interval while the virtual machine is running after the source virtual machine disk is replicated to the target virtual machine disk. The migration unit may be configured to regularly reflect the snapshot on the replication stored in the target virtual machine disk at the given interval while the virtual machine is running.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1 shows a virtual machine performing virtual machine disk migration between a first storage device and a second storage device in accordance with an embodiment of the present invention;

FIG. 2 shows a migration manager in accordance with an embodiment of the present invention; and

FIG. 3 shows a method for migrating a virtual machine disk from a first storage device to a second storage device in accordance with an embodiment of the present invention.

### DETAILED DESCRIPTION OF THE INVENTION

Reference will now be made in detail to embodiments of the present invention, examples of which are illustrated in the accompanying drawings, wherein like reference numerals refer to like elements throughout. The embodiments are described below, in order to explain the present invention by referring to the figures.

In accordance with an embodiment of the present invention, a virtual machine disk may be migrated from a first storage device to a second storage device based on a snapshot of variation between the first storage device and the second storage device.

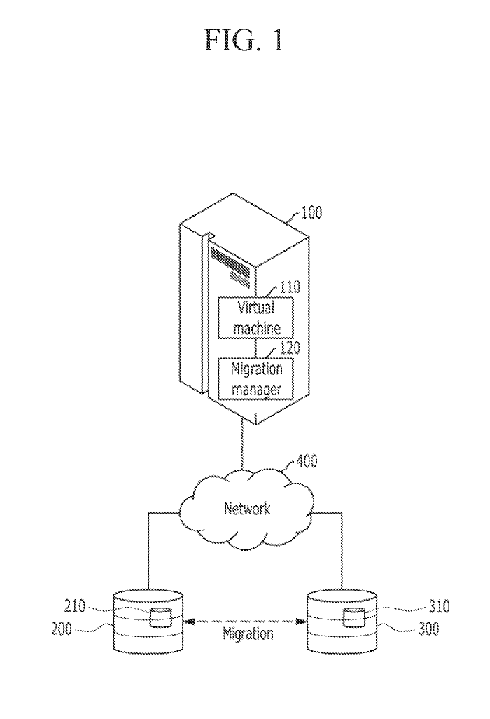

FIG. 1 shows a virtual machine performing virtual machine disk migration between a first storage device and a second storage device in accordance with an embodiment of the present invention.

Referring to FIG. 1, computing system 100 may be coupled to first storage device 20 and second storage device 300 through network 400 in accordance with an embodiment of the present invention. Although computing system 100 is illustrated as connected to first and second storage devices 200 and 300 through network 400, the present invention is not limited thereto. Such virtual machine 100 may be coupled to first and second storage devices 200 and 300 through various means, such as a cable, a wireless communication link, and an inter-bus. Such storage devices 200 and 300 may be implemented in the same computing system, generally a server. In this case, such virtual machine 100 ay be coupled to first and second storage devices 200 and 300 thorough an inter-bus.

Computing system include virtual machine 110 and migration manager 120 in accordance with an embodiment of the present invention. Computing system 100 may be a physical computer or a virtualized computing system. For example, computing system 100 may receive a request for a virtual machine from a user or other system and create virtual machine 110 using available resources in response to the request.

As described above, virtual machine 110 may be virtualized and installed in computing system 100. Virtual machine 110 may include at least one virtual machine disk created in first and second storage devices 200 and 300. Such virtual machine 110 may receive instructions from a user or other entity, perform necessary operations, and store results in associated virtual machine disks. Furthermore, virtual machine 110 may retrieve information from associated virtual machine disks. Virtual machine 110 may manage the associated virtual machine disks for better performance or efficiency. In order to efficiently manage or to perform maintenance, virtual machine 110 may perform virtual machine disk migration. The virtual machine disk migration may be a process of transferring a virtual machine disk from first storage device 200 to second storage device 300. Virtual machine 110 may perform such virtual machine disk migration through migration manager 120 in accordance with an embodiment of the present invention.

Migration manager 120 may perform virtual machine disk migration in cooperation with virtual machine 110 in accordance with an embodiment of the present invention. Migration manager 120 may be illustrated in FIG. 1 as an independent element from virtual machine 110. The present invention, however, is not limited thereto. Migration manager 120 may be realized as a virtualized constituent element of virtual machine 110.

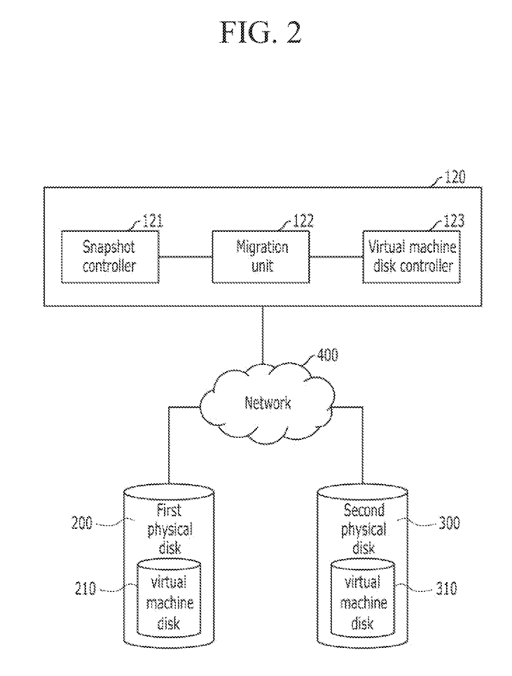

In accordance with an embodiment of the present invention, migration manager 120 may receive a migration request from virtual machine 110 and create virtual machine disk 310 using resources of second storage device 300 in cooperation with virtual machine 110. After creation, migration manager 120 may replicate virtual machine disk 210 of first storage device 200 to virtual machine disk 310 of second storage device 300. Since virtual machine disk 210 is constantly changed while virtual machine 110 is running, migration manager 120 may regularly and constantly detect variation of virtual machine disk 210 based on the replication stored therein at a given interval. Migration manager 120 may create a snapshot of the detected variation and reflect the snapshot on the replication stored in virtual machine disk 310 of second storage device 300. For example, migration manager 120 may update the replication with the variation based on the snapshot. Migration manager 120 may assign virtual machine disk 310 as a designated virtual machine disk. Since virtual machine disk 210 may be changed while and after assigning, a final variation and a final snapshot may be created. Migration manager 120 may complete the migration process by reflecting the final snapshot on virtual machine disk 310 of second storage device 300. Such an operation of migration manager 120 is described subsequently with reference to FIG. 2.

First storage device 200 and second storage device 300 may be coupled to computing system 100 through network 400 as described above. First storage device 200 and second storage device 300 may include at least one virtual machine disk created by virtual machine 110. First storage device 200 and second storage device 300 may be illustrated in FIG. 1 as separate storage devices coupled through network 400. The present invention, however, is not limited thereto. First storage device 200 and second storage device 300 may be two separate storage spaces located in one storage device. Furthermore, first storage device 200 and second storage device 300 may be a part of a storage area network (SAN) or a network attached storage (NA).

In accordance with an embodiment of the present invention, first storage device 200 may include virtual machine disk 210 created by virtual machine 110 and second storage device 300 may include virtual machine disk 310 created by virtual machine 110. Virtual machine disk 210 may be assigned to virtual machine 110 as a designated virtual machine. Such designated virtual machine disk 210 may store data associated with virtual machine 110. For example, virtual machine disk 210 may be files or sets of files stored by virtual machine 110. As virtual machine 110 is running, such data stored in al machine disk 210 may be changed constantly. Virtual machine 110 may migrate virtual machine disk 210 from first storage device 200 to third storage device 300 through migration manager 120 in accordance with an embodiment of the present invention. Hereinafter, migration manager 120 will be described with reference to FIG. 2.

FIG. 2 shows a migration manager in accordance with an embodiment of the present invention.

Referring to FIG. 2, migration manager 120 may include snapshot controller 121, migration unit 122, and virtual machine disk controller 123. As shown in FIG. 2, migration manager 120 may be coupled to first storage device 200 and second storage device 300 through network 400. Migration manager 120 may control and manage virtual disk migration from first storage device 200 to second storage device 300 in cooperation with virtual machine 110.

Migration unit 122 may receive a migration request from virtual machine 110, but the present invention is not limited thereto. Upon the receipt of the migration request, migration unit 122 may create virtual machine disk 310 in second storage device 300 and replicate virtual machine disk 210 of first storage device 200 to virtual machine disk 310 of second storage device 300. For example, replication of virtual machine disk 210 may be stored in virtual machine disk 310 of second storage device 300. As described above, virtual machine disk 210 is constantly changed while virtual machine 110 is running. Such variation of virtual machine disk 210 is desirably reflected on the replication stored in virtual machine disk 310 of second storage device 300. Accordingly, migration manager 120 may regularly and continuously reflect the variation of virtual machine disk 210 on the replication stored in second storage device 300 during a migration process using snapshots created by snapshot controller 121.

Snapshot controller 121 may regularly and continuously detect variation of virtual machine disk 210 of first storage device 200 based on the replication stored in virtual machine disk 310 of second storage device 300 during the migration process. Snapshot controller 121 may create a snapshot of the detected variation. The snapshot may be the state of variation at a particular point in time.

In accordance with an embodiment of the present invention, snapshot controller 200 may compare the replication stored in virtual machine disk 310 of second physical disk 300 with virtual machine disk 210 of first physical disk 200 or compare virtual machine 210 with virtual machine disk 310 after virtual machine disk 210 of first physical disk 200 is replicated to second physical disk 300. Based on the comparison result, snapshot controller 200 may determine variation of virtual machine disk 210. Snapshot controller 200 may create a snapshot of the determined variation. Snapshot controller 200 may constantly and regularly create the snapshot of variations at a given interval. Migration unit 210 may regularly and continuously reflect the snapshots on the replication stored in second storage device 300. For example, migration unit 210 may update the replication stored in second storage device 300 with the detected variation based on the snapshots. Snapshot controller 200 may also detect a final variation and create a final snapshot after virtual machine disk 310 is assigned to virtual machine 110 as a designated virtual machine disk. Such final snapshot may be reflected on virtual machine disk 310 to complete the migration process.

Virtual machine disk controller 220 may assign virtual machine disk 310 of second storage device 300 as a designated virtual machine disk for virtual machine 110 after virtual machine disk 210 of first physical disk 200 is replicated to virtual machine 310 of second physical disk 300 and the variations are all reflected on the replicas of second physical disk 300. That is, virtual machine disk controller 220 may change a designated virtual machine disk for virtual machine 110 from virtual machine disk 210 of first storage device 200 to virtual machine disk 310 of second storage device 300. Since virtual machine disk 210 of first storage device 200 is continuously changed due to virtual machine 110 is in operation after assigning, snapshot controller 121 may create a final snapshot for detected variation and migration unit 122 may reflect the final snapshot on the replications of second storage device 300, thereby completing the migration process.

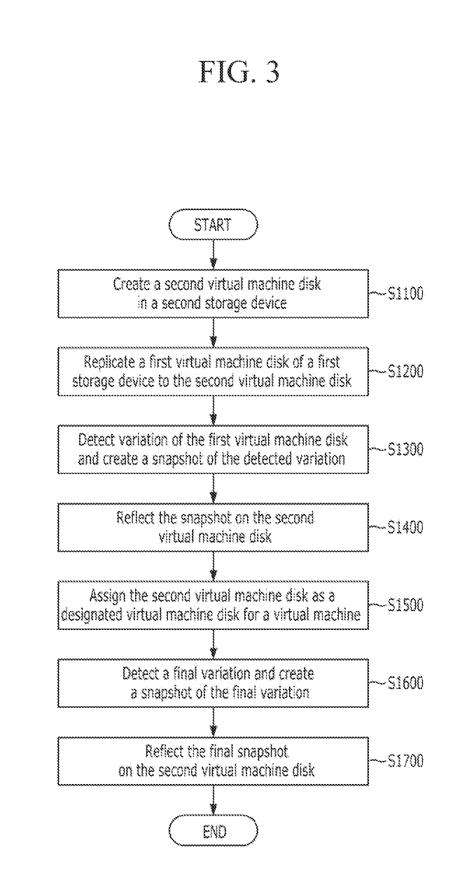

Hereinafter, a migration operation of virtual machine 110 in accordance with an embodiment of the present invention will be described with reference to FIG. 3.

FIG. 3 shows a method for migrating a virtual machine disk from a first storage device to a second storage device in accordance with an embodiment of the present invention. For convenience and ease of understanding, the method will be described as migrating a first virtual machine disk from a first storage device to a second virtual machine disk in a second storage device. For example, the first virtual machine disk may be virtual machine disk 210 in first storage device 200 and the second virtual machine disk may be virtual machine disk 310 in second storage device 300, which are shown in FIG. 1.

Referring to FIG. 3, at step S1100, a second virtual machine disk may be created at a second storage device. For example, virtual machine 110 may receive a migration request from a user or a system and initiate migration manager 120 in response to the migration request. The creation of a virtual machine disk may be performed through virtual chine 110 or migration manager 120, but the present invention is not limited thereto. For convenience and ease of understanding, migration manager 120 is described as creating a virtual machine disk on a destination storage device, for example, second storage device 300. Migration manager 120 may create virtual machine disk 310 using resources of second storage device 300. The present invention, however, is not limited thereto. Migration manager 120 may create virtual machine disk 310 using resources of a plurality of storage devices connected through a network or a cable. Virtual machine disk 310 may have a size equal to or greater than that of virtual machine disk 210 of first storage device 200.

At step S1200, a first virtual machine disk of a first storage device may be replicated to the second virtual machine disk of the second storage device. For example, migration manager 120 may virtual machine disk 210 of first storage device 200 to virtual machine disk 310 of second storage device 300 while virtual machine 110 is running. Virtual machine disk 210 is frequently and constantly changed while virtual machine 110 is running. Accordingly variation of virtual machine disk 210 may be required to be reflected on the replication stored in virtual machine disk 310 of second storage device 300.

At step S1300, variation of the first virtual machine may be detected and a snapshot may be created based on the detected variation. For example, migration manager 120 may continuously and regularly detect variation of virtual machine disk 210 of first storage device 200 based on the replication stored in virtual machine disk 310 of second storage device 300 at a regular interval. In order to detect the variation, migration manger 120 may compare virtual machine disk 210 of first storage device 200 with virtual machine disk 310 of second storage device 300. Based on the comparison result, migration manager 120 may detect the variation of virtual machine disk 210. Migration manger 120 may create a snapshot of the detected variation.

At step S1400, the snapshot may be reflected on the replication stored in the second virtual machine disk. For example, migration manager 120 may reflect the snapshot on the replication stored in virtual machine disk 320 of second storage device 300. Particularly, migration manager 120 may update the replication with the detected variation based on the snapshot. Since the variation detection and the creation snapshot may be performed regularly at a given interval, the snapshot reflection may be also performed regularly at a given interval, but the present invention is not limited thereto.

At step S1500, the second virtual machine disk may be assigned as a designated virtual machine disk for a related virtual machine. For example, migration manager 120 may assign virtual machine disk 310 of second storage device 200 as a designated virtual machine disk of virtual machine 110.

At step S1600, final variation of the first virtual machine may be detected and a final snapshot may be created based on the detected variation. For example, migration manager 120 may detect the final variation of virtual machine disk 210 of first storage device 200 based on the replication stored in virtual machine disk 310 of second storage device 300 right after assigning the second virtual machine disk as a new virtual machine disk for the related virtual machine. Migration manger 120 may create a final snapshot of the detected final variation.

At step S1700, the final snapshot may be reflected on the replications stored in the second virtual machine disk. For example, migration manager 120 may reflect the final snapshot on the replication stored in virtual machine disk 310 of second storage device 300. By reflecting the final snapshot on the replication stored in virtual machine disk 310, the migration process may be completed. After completing the migration process, virtual machine disk 210 of first storage device 200 may be released, but the present invention is not limited thereto. Without releasing, virtual machine 110 may use virtual machine disk 210 for another purpose.

As described above, embodiments of the present invention may be described as using the snapshot for reflecting variation of an original virtual disk on a target virtual disk for migration. The present invention, however, is not limited thereto. For example, variation may be detected and stored in various forms such as data or files. Such detected variation may be reflected on the target virtual machine disk using the stored data or files.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, e articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and component may be localized on one computer and/or distributed between two or more computers.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of migrating a source virtual machine disk of a virtual machine from a first storage device to a second storage device while the virtual machine is running, the method comprising:
creating a target virtual machine disk in the second storage device;
replicating the source virtual machine disk of the first storage device to the target virtual machine disk in the second storage device;
detecting variation of the source virtual machine disk;
reflecting the detected variation on the replication stored in the target virtual machine disk in the second storage device; and
assigning the target virtual machine disk of the second storage device as a designated virtual machine disk for the virtual machine.

2. The method of claim 1, comprising performing the detecting variation and the reflecting the detected variation regularly at a given interval.

3. The method of claim 1, wherein the detecting variation includes: comparing the source virtual machine disk with the replication stored in the target virtual machine disk of the second storage device.

4. The method of claim 1, wherein the detecting variation includes:
comparing the source virtual machine disk with the target virtual machine disk of the second storage device.

5. The method of claim 1, wherein the reflecting the detected variation includes:
creating a snapshot of the detected variation; and
reflecting the snapshot on the replication stored in the virtual machine disk of the second storage device.

6. The method of claim 5 wherein the reflecting snapshot includes: updating the replication stored in the virtual machine disk of the second storage device based on the variation included in the snapshot.

7. The method of claim 1, after the assigning, comprising:
detecting a final variation of the source virtual machine disk; and
reflecting the final variation on the replication stored in the target virtual machine disk.

8. The method of claim 5, after the assigning, comprising:
detecting a final variation of the source virtual machine disk;
creating a final snapshot of the final variation; and
reflecting the final snapshot on the replication stored in the target virtual machine disk.

9. A method of migrating a source virtual machine disk of a virtual machine from a first storage device to a second storage device while the virtual machine is running, the method comprising:
replicating the source virtual machine disk of the first storage device to the second storage device;
detecting variation of the source virtual machine disk;
reflecting the detected variation on the replication stored in the second storage device; and
assigning the second storage device as a designated storage device for the virtual machine.

10. The method of claim 9, comprising performing the detecting variation and the reflecting the detected variation regularly at a given interval.

11. The method of claim 9, wherein the detecting variation includes: comparing the source virtual machine disk with the replication stored in the second storage device.

12. The method of claim 9, wherein the reflecting the detected variation includes:
creating a snapshot of the detected variation; and
reflecting the snapshot on the replication stored in the second storage device.

13. The method of claim 12, wherein the reflecting the snapshot includes: updating the replication stored in the second storage device based on the variation included in the snapshot.

14. The method of claim 9, wherein the assigning includes:
creating a target virtual machine disk with the replication stored in the second storage device; and
assigning the created target virtual machine disk as a designated virtual machine disk for the virtual machine.

15. The method of claim 9, after the assigning, comprising:
detecting a final variation of the source virtual machine disk; and
reflecting the final variation on the replication stored in the target virtual machine disk.

16. The method of claim 12, after the assigning, further comprising:
detecting a final variation of the source virtual machine disk;
creating a final snapshot of the final variation; and
reflecting the final snapshot on the replication stored in the target virtual machine disk of the second storage device.

17. A virtual machine for migrating a virtual machine disk from a first storage device to a second storage device while the virtual machine is running, the virtual machine comprising:
a migration unit configured to create a target virtual machine disk in the second storage device and to replicate the source virtual machine disk of the first storage device to the target virtual machine disk in the second storage device;
a snapshot controller figured to detect variation of the source virtual machine disk and to create a snapshot of the detected variation; and
a virtual machine disk controller configured to assign the target virtual machine disk of the second storage device as a designated virtual machine disk for the virtual machine,
wherein the migration unit is configured to reflect the detected variation on the replication stored in the target virtual machine disk in the second storage device based on the snapshot.

18. The virtual machine of claim 17, wherein the snapshot controller is configured to:
compare the source virtual machine disk with the replication stored in the target virtual machine disk of the second storage device; and
create the snapshot based on the comparison result.

19. The virtual machine of claim 17, wherein:
the snapshot controller is configured to detect a final variation of the source virtual machine disk and to create a final snapshot of the final variation, after the virtual machine disk controlled assigns the target virtual machine disk as the designated virtual machine disk for the virtual machine, and
the migration unit is configured to reflect the final variation on the replication stored in the target virtual machine disk after the virtual machine disk controlled assigns the target virtual machine disk as the designated virtual machine disk for the virtual machine.

20. The virtual machine of claim 17, wherein:
the snapshot controller is configured to regularly detect and create the variation and the snapshot at a given interval while the virtual machine is running after the source virtual machine disk is replicated to the target virtual machine disk; and
the migration unit is configured to regularly reflect the snapshot on the replication stored in the target virtual machine disk at the given interval while the virtual machine is running.
